(19) United States
(12) Patent Application Publication
(10) Pub. No.: US 2022/0159344 A1
(43) Pub. Date: May 19, 2022

(54) SYSTEM AND METHOD FUTURE DELIVERY OF CONTENT

(71) Applicant: Eric Louis Gutierrez, Lubbock, TX (US)

(72) Inventor: Eric Louis Gutierrez, Lubbock, TX (US)

(21) Appl. No.: 17/530,992

(22) Filed: Nov. 19, 2021

Related U.S. Application Data
(60) Provisional application No. 63/116,016, filed on Nov. 19, 2020.

(51) Int. Cl. H04N 21/4788; H04N 21/234; G03H 1/08; H04N 21/4415

(52) U.S. Cl. CPC H04N 21/4788; H04N 21/4415; G03H 1/08; H04N 21/23424

(57) ABSTRACT

An intended recipient is named to view the content posted by the user not before but on the release date. The intended recipient is notified prior to the release date that they have a pending post and the date on which it will become available for viewing. The user posting is presented in an interactive audio, video, and holographic presentation to the intended recipient.

### CROSS REFERENCE TO RELATED APPLICATIONS

This patent application claims priority from U.S. Provisional Patent Application Ser. No. 63/116,016 filed on November 19, by Eric Louis Gutierrez and entitled, “A System and Method Future Delivery of Content” which is hereby incorporated by reference in its entirety.

### BACKGROUND OF THE INVENTION

There is a need for users to preserve content for viewing in the future, upon death or the occurrence of a particular event.

### FIELD OF THE INVENTION

The field of the invention is storing content for viewing at a future date.

### SUMMARY OF THE INVENTION

An intended recipient is named to view the content posted by the user not before but on the release date. The intended recipient is notified prior to the release date that they have a pending post and the date on which it will become available for viewing. An interactive script is created for responding to an intended recipient in video, audio, and holographic presentation.

### BRIEF DESCRIPTION OF THE DRAWINGS

FIG. 1 is a schematic depiction of a particular illustrative embodiment of the invention showing a registration screen graphical user interface;

FIG. 2 is a schematic depiction of a particular illustrative embodiment of the invention showing a system overview graphical user interface;

FIG. 3 is a schematic depiction of a particular illustrative embodiment of the invention showing a topic selection graphical user interface; and

FIG. 4 is a flow chart for a particular embodiment of the invention.

The drawings presented herein are for illustrative purposes only and do not limit the scope of the claims. Rather, the drawings are intended to help enable one having ordinary skill in the art to make and use the claimed inventions.

### DETAILED DESCRIPTION OF AN ILLUSTRATIVE EMBODIMENT OF THE INVENTION

Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in at least one printed publication, dictionary, or issued patent.

Certain specific embodiments of methods, structures, elements, and parts are described below, which are by no means an exclusive description of the inventions. Other specific embodiments, including those referenced in the drawings, are encompassed by this application and any patent that issues therefrom.

A particular illustrative embodiment of the invention is disclosed herein in which a platform such as a web based, or mobile-based application receives content from users and enables users to post the content on the web site for release in the future. The user content posted in the platform is not available for viewing by the recipient until the release date in the future, wherein the content is data in the form of a text, audio, photographs, video, personal history, holographic images, voice profile, video profile and artificial intelligence generated personality profile.

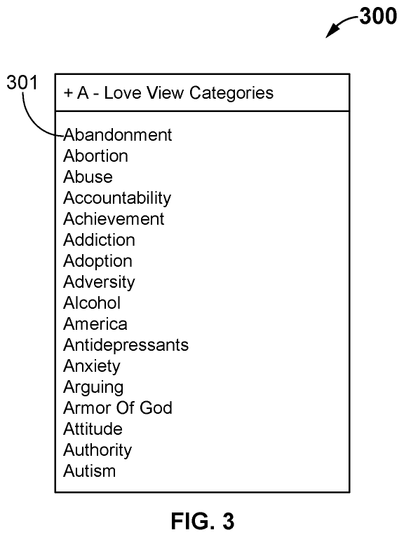

An intended recipient is named to view the content posted by the user not before but on the release date. The intended recipient is notified prior to the release date that they have a pending post and the date on which it will become available for viewing. The platform notifies the recipient using waterfall drip notification algorithm, immediately after the user posts the user content and thereafter sends a periodic reminder to the recipient on an accelerating time scale. For example, in one example of the waterfall drip notification the posted video which will be released and available for viewing in 5 years. Subsequent reminders are sent to the intended recipient after 1 year, 1 notification every 6 months the second year, 1 notification every 3 months during the third year, once a month during the fourth year and once a week during the fifth year. Subsequent reminders are sent to the recipient on a weekly basis until the recipient requests cessation of the notifications. Once the release date at the fifth year is reached, a notification is sent to the recipient that the video is available for viewing. The content is posted in the future for viewing upon the occurrence of a particular event which could be marriage of the intended recipient or the death of the sender. The sender can select a category for posting and a recipient who is a member of the sender's group can search through categories of posts that have been posted by the sender. As shown in FIG. 3, in a particular illustrative embodiment of the invention, the sender (user) can select a topic in list 301 of categories from a processor generated graphical user interface presented on a display, in which to a user posts sender (user) data including but not limited to personal history, videos, photographs, quotes from books, demographic information, likes and dislikes and preferences on topics such as Abandonment, Abortion, Abuse, Accountability, Achievement, Addiction, Adoption, Adversity, Alcohol, America, Antidepressants, Anxiety, Arguing, Armor of God, Attitude, Authority, Autism, etc.

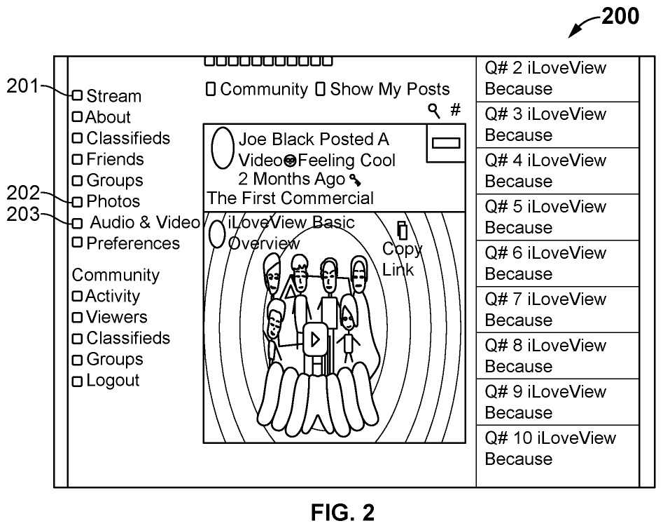

In a particular illustrative embodiment of the invention a processor accepts sender (user) input from a sender (user) on the graphical user interface as shown in FIG. 2 including but not limited to personal history, videos, photographs, quotes from books, demographic information, likes and dislikes and preferences and uses the data from the personal history, to create holographic images, user voice profile, user video profile and artificial intelligent personality profile to store the data in the non-transitory computer readable medium data fields whereby the processor uses the data stored in the non-transitory computer readable medium data fields to create an interactive conversation script between the intended recipient and the sender (user). In a particular illustrative embodiment of the invention, the user, an interactive script is created and presented to an intended recipient in a question and answer format using the user's simulated voice and a video of the user, wherein the intended recipient asks a question, and the sender (user) responds to the intended recipient's question. In another particular illustrative embodiment of the invention, the user, an interactive script is created and presented to an intended recipient in a question and answer format using the user's simulated voice and a video of the user, wherein the intended recipient asks a question, and the sender (user) responds to the intended recipient's question in the user's simulated voice and a segment of a prerecorded video from the user. In another particular illustrative embodiment of the invention, the user, an interactive script is created and presented to an intended recipient in a question and answer format using the user's simulated voice. In another particular illustrative embodiment of the invention, the interactive script is implemented in a question and answer format using the user's simulated voice and a hologram of the user. Each of the appended claims defines a separate invention which, for infringement purposes, is recognized as including equivalents of the various elements or limitations specified in the claims.

The sender (user data) is parsed by the processor into an interactive script to respond to an intended user questions in an interactive audio, video, and holographic presentation to the intended recipient at the intended user end user device including but not limited to a processor and a computer program stored in a non-transitory computer readable medium.

In a particular illustrative embodiment of the invention, a sender (user) signs into the platform having a processor, computer program and non-transitory computer readable medium, hosting the invention and enters a user (sender) user data, including but not limited to personality profile data. The personality profile data includes but is no limited to the user's family tree, personal likes and dislikes for persons, places, and things. The user also enters favorite passages from books, spiritual passages, foods, recipes, sports team as well as a video data, holographic data, photograph data and legal records as part of the personality profile data. The processor stores the user's personality profile data input in the non-transitory computer readable medium and uses the personality profile data input to create an enhanced personality profile to generate interactive scripts that are presented to an intended recipient as a voice, voice and video and voice and hologram interactive session between the intended recipient and the user.

A processor generates an interactive script enabling the intended recipient to interact with the user interactively in the user's simulated voice and in a video and a hologram. A user can request that a user read recipient or sender selected texts in sender and/or recipients voice from script based on the personality profile of the user or another user. A user (sender) can visit an intended recipient in person as a hologram of another user or as themselves and converse in their voice with interactive voice activated script. An interactive voice activated question and answer system is provided to provide an intended recipient the ability to ask questions of and converse with another user based on the personality profile.

An intended recipient can “talk”, that is exchange audible and visual data with a sender using the processor generated sender's enhanced personality profile data and an interactive voice activated question and answer script generated by the processor on the system platform. An intended recipient asks questions of and hear answers from the sender to the questions from recipient in the sender's own voice taken from the user's input and from a simulated voice of the user created to use the script to answer the intended recipient's questions that were not entered by the user. An intended recipient can view a video response from another user or themselves based on the personality profile of the user.

An intended recipient and a user can view a hologram response from another user or themselves based on the personality profile. Virtual offspring from selected persons is generated from the family tree and the personality profile. Artificial intelligence is used to create the user's response based on the personality profile and enhanced personality profile to create audio responses, video responses and holographic responses in an interactive script created by the processor from the user's enhanced personality profile.

In another particular embodiment of the invention, the inventions enables the system to “save time”, that is, to capture and store a moment or experience from a sender (user) to be accessed by another to experience that saved time after the time at which the experience actually occurred.

In another particular embodiment, the system enables the processor to develop an enhanced personality profile for user based on use's personal history and personality profile input by the user. The personal history includes demographic information including but not limited to birth date, birthplace, gender, family tree, education, race and personal affinities for sports, books, activities, personal videos, voice recordings, life skills, anecdotes, and photos.

The system further develops the family trees using online searches of data bases such as ANCESTRY.DOM TRADEMARK. The system further develops a life story and opinion based on the personal history. For example, a male carpenter from Alabama born in 1933 would have a life story augmented and supplemented by the beliefs, attitudes, and traditions of the similar demographic population by the processor to create an enhanced personality profile for the user.

In another embodiment, the system generates an interactive hologram script of the user so that a recipient converses with the user interactively. An intended recipient interacts with a voice activated system script associated with the interactive hologram converse with the hologram. An artificial intelligence system develops an enhanced life story (also referred to herein as an enhanced personality profile) based on the user's personality profile input by the user. The enhanced life story generated by the processor is based on the user's life story and is enhanced by extrapolating the life story to include beliefs, attitudes, and traditions of the similar demographic population.

In another particular embodiment of the invention, a moment in time is saved by archive a user's video so that the archived video is a saved moment in time to be viewed later. In another particular embodiment, the user provides advice and comments on particular topics. The system provides an interpolated response to topics that are not covered by the user by formulating responses based on the user's enhanced life story in a script generated by the processor.

In another particular embodiment of the invention, the system delivers an age appropriate response to the recipient based on the recipient's age in an interactive hologram, video, or audio response. In another particular embodiment of the invention, age adjustment is performed on the image of the user presented in the interactive hologram and video to show the user's their current age, an older age, or a younger age even after the death of the user.

A voice sample from the user is provided to deliver simulated and emulated audio responses to the recipient in a simulation and emulation of the (sender's) user's voice. The following issued patent and published patent applications are hereby incorporated by reference in their entirety to provide enabling and descriptive current technologies upon which the present invention improves upon and to demonstrate the state of the art in the following technologies.

### Face Age Changing Technology

U.S. Pat. No. 10,593,083 by Kim, et al. Mar. 17, 2020, entitled, Method for facial age simulation based on age of each part and environmental factors, recording medium and device for performing the method, which is hereby incorporated by reference in its entirety.

Abstract Disclosed is a method for facial age simulation based on an age of each facial part and environmental factors, which includes: measuring an age of each facial part on the basis of an input face image; designating a personal environmental factor; transforming an age of each facial part by applying an age transformation model according to the age of each facial part and the environmental factor; reconstructing the image transformed for each facial part; and composing the reconstructed images to generate an age-transformed face. Accordingly, it is possible to transform a face realistically based on an age measured for each facial part and an environmental factor.

U.S. Pat. No. 10,860,755 Martin, et al. Dec. 8, 2020, entitled, Age modelling method, which is hereby incorporated by reference in its entirety.

Abstract A method for modelling age-related traits of a face, from a picture of the face is provided, wherein the age-related traits are either wrinkles or age spots, the method including for each age-related trait of the face of the same nature, generating a vector including parameters of shape and appearance of the trait; and generating, from the generated vectors, a single representation vector modeling the age-related traits of the same nature in the face. The single representation vector stores information regarding the number of traits in the face and joint probabilities, over the face, of the shape and appearance features of the traits.

### Interactive Audio, Video and Hologram Technology

U.S. Pat. No. 4,669,812 by Hoebing Jun. 2, 1987, entitled, Method and apparatus for 3-D image synthesis, which is hereby incorporated by reference in its entirety.

Abstract Method and apparatus for production of 3-D images (volume displays) from a set of 2-D images employing one or more multiple component holographic optical elements (mcHOEs) in combination with an off-axis array of a plurality of 2-D illuminated (or radiative) components of objects to be synthesized into 3-D images of the objects. An array of component regions is disposed in at least one plane generally normal to a defined optical axis. A mcHOE is disposed in a plane parallel to the plane of the array with the optical axis passing therethrough. The components are illuminated from behind, or are themselves radiative (as, for example, in the case of CRT screen(s)). The observer is positioned along the optical axis in front of the mcHOE. The mcHOEs are virtual image transmission or reflection holograms, but real images may be produced by using the appropriate mcHOE. The component region array is a set of 2-D representations of portions of an object (e.g., each member of the array being a section of the 3-D object to be reconstructed at a unique depth within the object). The component regions are successively illuminated, presented, or turned on (in the case of a radiative region), by a light source having a narrow wavelength band substantially similar to that by which the mcHOEs were made. Diffuser screens and/or filters may be employed. When the rate of illumination of each number of array in sequence exceeds the flicker fusion threshold of the observer, the individually projected planes of the array fuse into a 3-D image. By a variety of techniques, the invention is adaptable to applications in various fields, including scientific, technical, medical, entertainment, educational, commercial, and advertising. Specific examples shown include real image production, rotation or translation of reconstructed 3-D object images, 3-D holographic television, conjugate back focal plane hologram microscope, interactive 3-D holographic game devices, and the like.

U.S. Pat. No. 10,163,111 by Navaratnam, issued Dec. 25, 2018, entitled Virtual photorealistic digital actor system for remote service of customers, which is hereby incorporated by reference in its entirety.

Abstract A system for remote servicing of customers includes an interactive display unit at the customer location providing two-way audio/visual communication with a remote service/sales agent, wherein communication inputted by the agent is delivered to customers via a virtual Digital Actor on the display. The system also provides for remote customer service using physical mannequins with interactive capability having two-way audio visual communication ability with the remote agent, wherein communication inputted by the remote service or sales agent is delivered to customers using the physical mannequin. A web solution integrates the virtual Digital Actor system into a business website. A smart phone solution provides the remote service to customers via an App. In another embodiment, the Digital Actor is instead displayed as a 3D hologram. The Digital Actor is also used in an e-learning solution, in a movie studio suite, and as a presenter on TV, online, or other broadcasting applications.

U.S. Pat. No. 11,115,529 Agarwal, et al. Sep. 7, 2021

Entitle, System and method for providing and managing third party content with call functionality, which is hereby incorporated by reference in its entirety.

Abstract: Systems and methods for implementing an online content item campaign with selective call functionality can include a processor determining a rendering frequency of instances of a third-party content item for rendering with a call icon, based on a resource of the third-party content provider. The processor can provide a first instance of the content item for rendering with the call icon in accordance with the rendering frequency of instances. A call bridge device can receive a call from the client computing device upon actuation of the call icon, direct the call to a phone number of the third-party content provider, and determine a parameter of the call. The processor can adjust the rendering frequency of instances based on the parameter of the call and provide instances of the content item for display by client computing devices with the call icon in accordance with the adjusted rendering frequency of instances.

U.S. Pat. No. 11,107,465 Gustman, et al. Aug. 31, 2021, entitled, Natural conversation storytelling system, which is hereby incorporated by reference in its entirety.

Abstract: The present application discloses a multi-media interactive story-telling system that provides natural conversational interactions between a human user and a contributor who appears in multi-media recordings. The multi-media interactive story-telling system includes an intake device for recording interview sessions in which a contributor tells a life story about her life experience. The contributor may rely on a script when creating the life story. The multi-media interactive story-telling system further comprises storage devices for storing the recorded interview sessions and processors for organizing the recorded interview sessions. The multi-media interactive story-telling system further comprises an interactive device for retrieving and playing a recorded interview session in response to a query from a user.

### User Profile Generation Technology

US 20160019627A1 Patent Application Publication by Musil et al. Pub. Date: Jan. 21, 2016, Entitled, Initial Profile Creation in A Media Recommendation System, which is hereby incorporated by reference in its entirety. Abstract: A method of operating a recommendation system comprises receiving one or more elements of identifying information for a first user and receiving one or more user demographic elements associated with the first user based on the received identifying information. The recommendation system generates an initial media preference profile from correlation between the one or more user demographic elements and media preferences known to be associated with the one or more user demographic elements.

United States Patent Application 20180108084 by Gomez Sanchez; Francisco M.; et al. published Apr. 19, 2018, entitled, Automated Cognitive Psychometric Scoring, which is hereby incorporated by reference in its entirety.

Abstract A computer-implemented method for automated psychometric scoring which includes: collecting applicant data pertaining to an application from an applicant, the data including the applicant's name, age and demographic information; collecting textual information posted by the applicant from social media; automatically obtaining a personality profile of the applicant computed from the textual information; building a consolidated applicant profile by joining the personality profile and the applicant data; inputting the consolidated applicant profile into a machine

learning model to compute an approval score with respect to approving or not approving the application; and outputting the approval score from the machine learning model.

### Voice Simulation of User Technology

United States Patent Application 20100298959 by Sekiguchi; Hiroshi published Nov. 25, 2010, entitled Speech Reproducing Method, Speech Reproducing Device, And Computer Program, which is hereby incorporated by reference in its entirety. Abstract This invention concerns a voice reproducing apparatus enabling itself to reproduce voice information in units of a vocal chunk while extracting the boundary position of vocal chunks. The apparatus comprises a vocal chunk extraction block (802) for storing address identification information representing the boundary addresses while extracting the boundary address of two of more vocal chunks and a reproducing block (803) for reproducing audio data series (801) of each vocal chunk from a specified reproduction starting point while specifying a starting point of audio data series (801) according to the stored address identification information. Especially, the vocal chunk extracting block (802) extracts a small amplitude zone included in an audio data series (801), selects a small amplitude zone sandwiched between two vocal chunks out of the extracted small amplitude zones, and specifies the boundary address of the two vocal chunks in the selected small amplitude zone as an address identification information.

U.S. Pat. No. 11,159,666 by Beecham, issued Oct. 26, 2021, entitled, Voice sounds characteristic of a celebrity configured to emanate from speaker co-located with figurine resembling said celebrity, which is hereby incorporated by reference in its entirety.

Abstract A method and system for entertainment comprising sound-producing signals communication to plurality of bobble head/vibrational devices (BH/VDs). Typically, at least some of said produced sounds resemble a first voice at least resembling a first celebrity's voice and at least some of said produced sounds resemble a second voice at least resembling a second celebrity's voice. System typically uses VoIP, cell phone apps and BH/VDs to enable subscribers to service to hear from speakers linked to BH/VDs a conversation comprising sounds at least resembling a first celebrity's voice and said sounds at least resembling a second celebrity's voice. The origin of said sounds can be an actual human celebrity speaking, a celebrity voice impersonator speaking, or an electronic simulation of celebrity voice. The system can be used in the home of subscribers, such as with a private event for delivering entertainment, wagering advice; or for public events, such as exercise classes, game shows, live events, recommunication events, and sporting events.

### Advertising Insertion into Video Technology

U.S. Pat. No. 11,151,614 Bradley, et al. Oct. 19, 2021 entitled, Advertisements blended with user's digital content, which is hereby incorporated by reference in its entirety.

Abstract: Disclosed are systems and methods for generating customized advertising content by combining one or more content items with advertising content. The content items may comprise various forms of media content, including, video, audio, etc. Users may utilize an interface to accesses advertising content and content items. In one embodiment, the user may utilize the interface to integrate one or more content items with advertising content to generate customized advertising content. The interface may be used to further modify the customized advertising content. A computing device may monitor on more user's consumption of customized advertising content for various purposes.

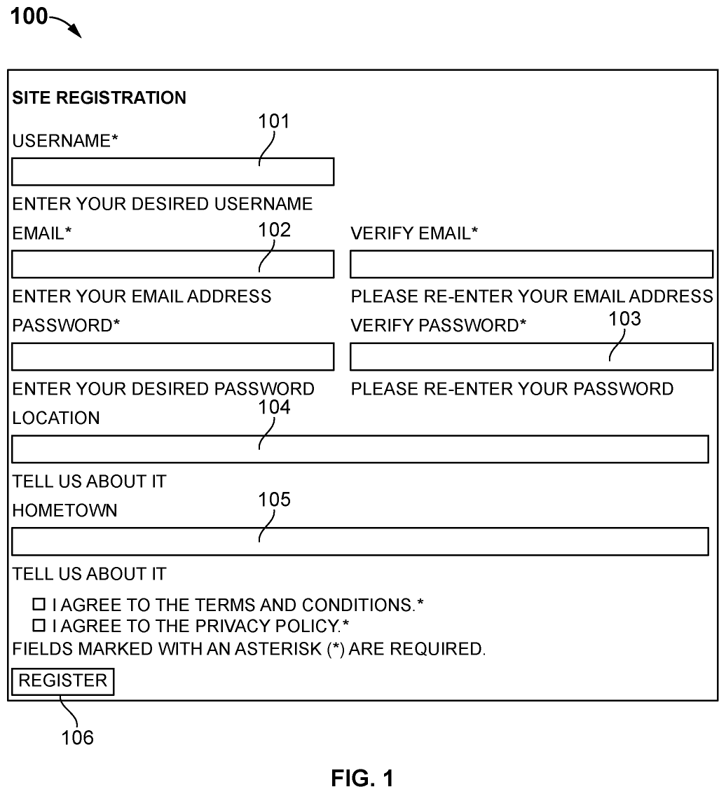

Turning now to FIG. 1, FIG. 1 is a schematic depiction of a particular illustrative embodiment of the invention. As shown in FIG. 1, a registration screen graphical user interface enables a user to register with the system. A user enters their profile and demographic information after registration, including but not limited to username 101, email address 102, password 103, location 104, hometown and register 106.

Turning now to FIG. 2, FIG. 2 is a schematic depiction of a particular illustrative embodiment of the invention. As shown in FIG. 2, As shown in FIG. 2, an overview screen graphical user interface enables a user to obtain an overview of the system. An intend recipient can select to view 201 stream, 202 photos or 203 audio and video.

Turning now to FIG. 3, FIG. 3 is a schematic depiction of a particular illustrative embodiment of the invention. As shown in FIG. 3 a topic screen graphical user interface is presented for a user to enter a video data or audio message data on a particular topic 301.

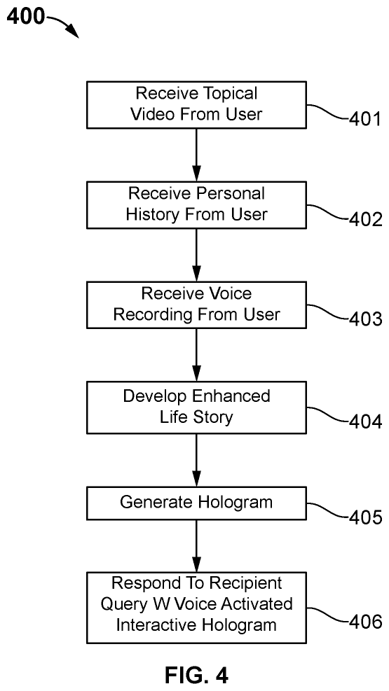

Turning now to FIG. 4, FIG. 4 is a flow chart for a particular embodiment of the invention. As shown in FIG. 4, in a particular illustrative embodiment of the system, a flow chart of functions is performed. At 401 the system receives a topical video data from the user. At 402 the system received a personal history including but not limited a personality profile from the user. At 403 the system receives a voice recording from the user. At 404 the system develops an enhanced life story and enhanced personality profile for the sender (user). At 405 the system generates a hologram for the user. At 406 the system responds to recipient queries using a voice activated interactive hologram.

In a particular illustrative embodiment of the invention, the following uploading algorithm in iLoveView for Video Posts and Recorded iLoveView is provided. Once the user picks a video or finishes recording their video, the corresponding video data file and entered into the processor via a graphical user interface, the video is then spliced on separate chunks or data segments having a maximum size of 1 megabyte (MB) each. Once the video is spliced on the separate data segments, the data segments file is then sent to the server using the FIFO (First in First Out) methodology.

Upon successful posting of the corresponding video material the video is then scheduled for combination using the commercially available Queues and Crons methodologies. Due to the type of business niche of iLoveView one of the revenue generation methods includes but is not limited to advertisement data inserted into the sender video data and presented to an intended recipient through the sender videos. Keeping the current upload algorithm in mind, advertisement data are served in a more unique and TV like way. That can be achieved in a two ways:

In a particular illustrative embodiment of the invention, the processor executes a computer program referred to herein as Advertising Administrator software program stored on a non-transitory computer readable medium is provided to insert advertising into uploaded user videos, interactive scripts for audio, video, and holographic presentations to an intended recipient.

Streaming—Using the streaming methodology the video file is combined in order to be converted to the proper file type, which is available for streaming, for example, X-Matroska or almost any other widely supported video format. Having the final video file converted, the converted video file is spliced on one megabyte chunks again and assigned search terms for the Advertising Administrator software program to choose advertisements which is shown between the different chunks of the video without the need of Play and Pause of the original uploaded video file. For this to be possible the Advertising Administrator software program chooses video Advertisements and advertising video data from the same video format type and chooses between which portions of the video content to put the advertisement. Pluses of this solution are that the Advertising Administrator software program dynamically changes the Advertisements between the video chunks without the need of regenerating another end video file which will be Advertisements “stuffed” or inserted into and in between the 1 megabyte video data segments. This solution provides an easier methodology for advertisement impressions tracking due to the fact that it'll be easier to know between exactly which video chunks have been inserted in a video, hologram, or voice script.

In the past, combined end video file (current way of creating playable video files for larger files) were created by combining the chunks into one final video file, which means that once the chunks are combined the end video file has to be spliced again in order to place Advertisements between the different chunks. However that doesn't mean by any means that's not possible. In order to build an Advertisements management system in this scenario the Advertising Administrator software program chooses how many types of the same video should be generated in case the Advertising Administrator software program decides to provide one video file with different or additional advertisements.

Following the logic of the Streaming Advertisements Management System computer program and artificial intelligence, the same solution works in this case as well. A word press dashboard works synchronously with all of the generated uploaded and generated videos, audios and holograms per different advertisement data type providers or different advertisement data combinations.

In a particular illustrative embodiment of the invention, a system is disclosed the system including but not limited to a processor; a non-transitory computer readable medium connected to the processor; a computer program stored in the computer readable medium, the computer program comprising computer instructions that are executed by the processor; a visual display connected to the processor; a graphical user interface generated by the processor and presented to a user on the visual display; a user interface that accepts user input data; a data base containing fields populated by the user input data, wherein the computer program further comprises, instructions to receive from the graphical user interface, an intended recipient data and store it an intended recipient data base field, instructions to receive from the graphical user interface, release criteria data and store it in a release criteria data base field, instructions to receive from the graphical user interface, user data and store it a user data base field, instructions to send notification data, upon satisfaction of the release criteria to the intended recipient indicating, that user data is available upon satisfaction of the release criteria; and instructions to send the user data to the intended recipient upon satisfaction of the release criteria data. In another particular embodiment of the invention the release criteria is a future date. All data mentioned herein, entered by the sender, and generated by the processor are stored in individual data in a data structure stored on the non-transitory computer readable medium on the system platform and accessed by the processor on the system processor.

In another particular embodiment of the invention the release criteria is occurrence of an event comprising death of user and marriage of the intended recipient. In another particular embodiment of the invention the user data is a video. In another particular embodiment of the invention the user data is a personality profile comprising demographic data, voice profile and photographs of the user. In another particular embodiment of the invention the personality profile is user voice data, family tree data, personal likes data, personal dislikes data for persons, places and things, favorite passages from books, spiritual passages, foods, recipes, sports teams. In another particular embodiment of the invention the personality profile is photographic data.

In another particular embodiment of the invention the computer program further includes but is not limited to instructions to generate an enhanced personality profile comprising holographic data, topical interactive voice activated script data, topical script data, and interactive voice activated holographic script data. In another particular embodiment of the invention , the computer program further includes but is not limited to instructions to separate the enhanced personality profile into one megabyte data segments, instructions to insert advertising data between the one megabyte data segments, instructions to combine the video file in order to be converted to the proper file type, which is available for streaming, for a given platform, instructions to splice the converted video file on chunks again in search terms for the Advertising Administrator software program, instructions to choose advertisements which will be shown between the different chunks of the video without the need of Play and Pause of the original video file, wherein Advertising Administrator software program chooses video Advertisements from the same video format type and chooses between which portions of the video content to put the advertisement, instructions to dynamically change the Advertisements between the video chunks without the need of regenerating another end video file which will be Advertisements “stuffed” or inserted into and in between the one megabyte video data segments, wherein this solution provides an easier methodology for advertisement impressions tracking due to the fact that it'll be easier to know between exactly which video chunks there is placed in a video, and instructions to present the one megabyte data segments and the advertising data to the intended recipient on the display.

In another particular embodiment of the invention the computer program further comprising instructions to present the interactive script data on the display to the intended recipient upon satisfaction of the release criteria. In another particular embodiment of the invention the computer program further includes but is not limited to instructions to present interactive hologram script data to the intended recipient, instructions to receive questions from the intended recipient, and instructions to respond in the interactive hologram script data to the questions with a response from the user in the interactive hologram script data.

In another particular embodiment of the invention the computer program further includes but is not limited to present the interactive voice activated script data to the intended recipient, instructions to receive questions from the intended recipient, and instructions to respond in the interactive voice activated script data to the questions with a response from the user in the interactive voice activated script data. In another particular embodiment of the invention the computer program further includes but is not limited to select advertising data based on a topic selected by the intended recipient.

In another particular embodiment of the invention the computer program further includes but is not limited to insert advertising data into the video segments data based on an occurrence of an event type in the criteria release data. In another particular embodiment of the invention the computer program further includes but is not limited to use artificial intelligence on the enhanced personality profile to respond to an intended recipient input by using demographic opinions associated with the user. In another particular embodiment of the invention the computer program further includes but is not limited to present user response data in the user voice profile making the voice response in the user's simulated voice.

In another particular embodiment of the invention the computer program further includes but is not limited to present user response data in user hologram data. In another particular embodiment of the invention the computer program further includes but is not limited to perform age adjustment on a user and present user response data in the age adjustment, making the user younger and older based on an intended recipient's request for an older and younger user. In another particular embodiment of the invention the computer program further includes but is not limited to use artificial intelligence to create an enhanced life story and opinion on topics based on the user demographic data enhanced with data based on user personal history and supplemented by beliefs, attitudes, and traditions of a similar demographic population of the user. In another particular embodiment of the invention the computer program further includes but is not limited to use artificial intelligence to generate an interpolated response from a user to an intend recipient question when a user response is not in the user profile data.

The present inventions can be realized in hardware, software, or a combination of hardware and software. In a specific embodiment, a system according to the present inventions can be realized in a centralized fashion in one computer system, or in a distributed fashion where different elements are spread across several interconnected computer systems. Any kind of computer system or other apparatus adapted for carrying out the methods and inventions described herein may be used for purposes of the present inventions. A typical combination of hardware and software could be a general-purpose computer system with a computer program that, when being loaded and executed, controls the computer system such that it carries out the methods and inventions described herein.

The figures herein include block diagram and flowchart illustrations of methods, apparatus(s) and computer program products according to various embodiments of the present inventions. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus may be used to implement the functions specified in the block, blocks, or flow charts. The flow chart is an example only and the steps shown in the flow chart need not be executed in the exact order shown on the flow chart. Moreover, some of the steps in the flow chart can be left out in performing the system and method of the present invention.

These computer program instructions may also be stored in a computer-readable medium or memory that can direct a computer or other programmable data processing apparatus to function in a particular manner, such that the instructions stored in the computer-readable medium or memory produce an article of manufacture including instructions which may implement the function specified in the block, blocks, or flow charts. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block, blocks, or flow chart.

Those skilled in the art should readily appreciate that programs defining the functions of the present inventions can be delivered to a computer in many forms, including but not limited to: (a) information permanently stored on non-writable storage media (e.g., read only memory devices within a computer such as ROM or CD-ROM disks readable by a computer I/O attachment); (b) information alterably stored on writable storage media (e.g., floppy disks and hard drives); or (c) information conveyed to a computer through communication media for example using wireless, baseband signaling or broadband signaling techniques, including carrier wave signaling techniques, such as over computer or telephone networks via a modem, or via any of the networks known. A diagram is shown illustrating an example of a computer that may be used in connection with the present inventions.

The computer may include at least one processor and at least one memory, each of which may be coupled to a local interface or bus. An operating system may be stored in the memory and executable by the processor. Any variety of software programs may also be stored in the memory and executable by the processor. In a specific embodiment, examples of programs that may be stored in the memory and executable by the processor. A media player application may be stored in the memory and executable by the processor. Also stored in the memory may be various forms of data. The term “executable” as used herein means that a program file is of the type that may be run by the processor. In specific embodiments, examples of executable programs may include without limitation: a compiled program that can be translated into machine code in a format that can be loaded into a random access portion of the memory and run by the processor; source code that may be expressed in proper format such as object code that is capable of being loaded into a random access portion of the memory and executed by the processor; or source code that may be interpreted by another executable program to generate instructions in a random access portion of the memory to be executed by the processor.

An executable program may be stored in any portion or component of the memory including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components. The memory may include both volatile and nonvolatile memory and data storage components. Volatile components are those that do not retain data values upon loss of power. Nonvolatile components are those that retain data upon a loss of power. Thus, the memory may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random-access memory (SRAM), dynamic random-access memory (DRAM), or magnetic random-access memory (MRAM) and other such devices. The ROM may comprise, for example, a programmable read-only memory (PROM), an erasable programmable read-only memory (EPROM), an electrically erasable programmable read-only memory (EEPROM), or other like memory device. In a specific embodiment, the processor may represent multiple processors and/or multiple processor cores and the memory may represent multiple memories that operate in parallel processing circuits, respectively. In such a case, the local interface may be an appropriate network that facilitates communication between any two of the multiple processors, between any processor and any of the memories, or between any two of the memories. The local interface may comprise additional systems designed to coordinate this communication, including, for example, performing load balancing. The processor may be of electrical or of some other available construction. Although the programs and other various systems, components and functionalities described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components. Such technologies are generally well known by those skilled in the art and, consequently, are not described in detail herein. The flowchart of FIG. 2 shows the functionality and operation of various specific embodiments of certain aspects of the present inventions. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s). Although the flowchart of FIG. 2 shows a specific order of execution, it is understood that the order of execution may differ from that which is depicted. For example, the order of execution of two or more blocks may be scrambled relative to the order shown. Also, two or more blocks shown in succession in FIG. 2 may be executed concurrently or with partial concurrence. Further, in some embodiments, one or more of the blocks shown in FIG. 4, may be skipped, or omitted. In addition, any number of counters, state variables, warning semaphores, or messages might be added to the logical flow described herein, for purposes of enhanced utility, accounting, performance measurement, or providing troubleshooting aids. It is understood that all such variations are within the scope of the present inventions. Any logic or application described herein that comprises software or code can be embodied in any non-transitory computer-readable medium, such as computer-readable medium, for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present inventions, a “computer-readable medium” may include any medium that may contain, store, or maintain the logic or application described herein for use by or in connection with the instruction execution system.

The computer-readable medium may comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random-access memory (RAM) including, for example, static random-access memory (SRAM) and dynamic random-access memory (DRAM), or magnetic random-access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device. The computer may further include a network interface coupled to the bus and in communication with a network. The network interface may be configured to allow data to be exchanged between computer and other devices attached to the network or any other network or between nodes of any computer system or the video system. In addition to the above description of the network, it may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, the network interface may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol. The computer may also include an input/output interface coupled to the bus and also coupled to one or more input/output devices, such as a display, a touchscreen, a mouse, or other cursor control device, and/or a keyboard. In certain specific embodiments, further examples of input/output devices may include one or more display terminals, keypads, touchpads, scanning devices, voice or optical recognition devices, or any other devices suitable for entering or accessing data by one or more computers. Multiple input/output devices may be present with respect to a computer or may be distributed on various nodes of computer system, the system and/or any of the viewing or other devices. In some embodiments, similar input/output devices may be separate from the computer and may interact with the compute or one or more nodes of computer system through a wired or wireless connection, such as through the network interface. It is to be understood that the inventions disclosed herein are not limited to the exact details of construction, operation, exact materials, or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. Accordingly, the inventions are therefore to be limited only by the scope of the appended claims. None of the claim language should be interpreted pursuant to 35 U.S.C. 112(f) unless the word “means” is recited in any of the claim language, and then only with respect to any recited “means” limitation.

1. A system, the system comprising:
a processor;
a non-transitory computer readable medium connected to the processor;
a computer program stored in the computer readable medium, the computer program comprising computer instructions that are executed by the processor;
a visual display connected to the processor;
a graphical user interface generated by the processor and presented to a user on the visual display;
a user interface that accepts user input data;
a data base containing fields populated by the user input data, wherein the computer program further comprises,
instructions to receive from the graphical user interface, an intended recipient data and store it an intended recipient data base field,
instructions to receive from the graphical user interface, release criteria data and store it in a release criteria data base field,
instructions to receive from the graphical user interface, user data and store it a user data base field,
instructions to send notification data, upon satisfaction of the release criteria to the intended recipient indicating, that user data is available upon satisfaction of the release criteria; and
instructions to send the user data to the intended recipient upon satisfaction of the release criteria data.

2. The system of claim 1, wherein the release criteria is a future date.

3. The system of claim 1, wherein the release criteria is occurrence of an event comprising death of user and marriage of the intended recipient.

4. The system of claim 1, wherein the user data is a video data.

5. The system of claim 1, wherein the user data is a personality profile comprising demographic data, voice profile data and photographs data of the user.

6. The system of claim 5, wherein the personality profile is user voice data, family tree data, personal likes data, personal dislikes data for persons, places and things data, favorite passages from books data, spiritual passages data, foods data, recipes data, and sports teams' data.

7. The system of claim 5 wherein the personality profile is photographic data.

8. The system of claim 6, the computer program further comprising:
instructions to generate on the processor, an enhanced personality profile comprising holographic data, topical interactive voice activated script data, topical script data, and interactive voice activated holographic script data.

9. The system of claim 8, the computer program further comprising instructions to separate the enhanced personality profile into one megabyte data segments,
instructions to insert advertising data between the one megabyte data segments,
instructions to combine the video file in order to be converted to the proper file type, which is available for streaming, for a given platform,
instructions to splice the converted video file on chunks again in search terms for the Advertising Administrator software program,
instructions to choose advertisements which will be shown between the different chunks of the video without the need of Play and Pause of the original video file, wherein Advertising Administrator software program chooses video Advertisements from the same video format type and chooses between which portions of the video content to put the advertisement, instructions to dynamically change the Advertisements between the video chunks without the need of regenerating another end video file which will be Advertisements “stuffed” or inserted into and in between the one megabyte video data segments, wherein this solution provides an easier methodology for advertisement impressions tracking due to the fact that it'll be easier to know between exactly which video chunks there is placed in a video,
and
instructions to present the one megabyte data segments and the advertising data to the intended recipient on an intended recipient display.

10. The system of claim 8, the computer program further comprising instructions to present the interactive script data on the display to the intended recipient upon satisfaction of the release criteria.

11. The system of claim 8, the computer program further comprising instructions to present interactive hologram script data to the intended recipient,
instructions to receive questions data from the intended recipient, and
instructions to respond in the interactive hologram script data to the questions with a response data from the user in the interactive hologram script data.

12. The system of claim 8, the computer program further comprising instructions to present the interactive voice activated script data to the intended recipient on an intended recipient device having a processor and non-transitory computer readable medium,
instructions to receive questions data from the intended recipient, and
instructions to respond in the interactive voice activated script data to the questions with a response from the user in the interactive voice activated script data.

13. The system of claim 8, the computer program further comprising instructions to select advertising data based on a topic selected by the intended recipient.

14. The system of claim 8, the computer program further comprising instructions to insert advertising data into the video segments data based on an occurrence of an event type in the criteria release data.

15. The system of claim 8, the computer program further comprising instructions to use artificial intelligence on the processor to process the enhanced personality profile to respond to an intended recipient input by using demographic opinions associated with the user.

16. The system of claim 8, the computer program further comprising instructions to present user response data in the user voice profile making the voice response in the user's simulated voice.

17. The system of claim 8, the computer program further comprising instructions to present user response data in user hologram data.

18. The system of claim 8, the computer program further comprising instructions to perform age adjustment on a user and present user response data in the age adjustment, making the user younger and older based on an intended recipient's request for an older and younger user.

19. The system of claim 8, the computer program further comprising instructions to use artificial intelligence to create an enhanced life story and opinion on topics based on the user demographic data enhanced with data based on user personal history and supplemented by beliefs, attitudes, and traditions of a similar demographic population of the user.

20. The system of claim 18, the computer program further comprising instructions to use artificial intelligence to generate an interpolated response from a user to an intend recipient question, when a user response is not in the user profile data.
